(19) United States
(12) Patent Application Publication
(10) Pub. No.: US 2026/0003345 A1
(43) Pub. Date: Jan. 1, 2026

(54) REMOTE HUMAN-MACHINE INTERFACE

(71) Applicant: SIDEL PARTICIPATIONS, Octeville-sur-Mer (FR)

(72) Inventors: Hervé PASQUIER, OCTEVILLE-SUR-MER (FR); David GARIOU, OCTEVILLE-SUR-MER (FR)

(21) Appl. No.: 19/247,015

(22) Filed: Jun. 24, 2025

(30) Foreign Application Priority Data
Jun. 28, 2024 (FR) 2407008

(51) Int. Cl. G05B 19/418; G05B 19/05

(52) U.S. Cl. CPC G05B 19/418; G05B 19/05; G05B 2219/14005

(57) ABSTRACT

Disclosed is a system for managing a production line. The system includes at least one human-machine interface (HMI) connected to a programmable logic controller (PLC), or to a distributed control system (DCS) of a machine of the production line, and/or a portable device. At least one remote terminal is rigidly connected to the machine or to a safety enclosure thereof and connected to the HMI or connected to the PLC. The remote terminal can detect the presence of the portable device inside a predetermined perimeter and connect the portable device to the HMI and/or to the PLC of the machine. The system also includes a device for generating vibrations capable of generating vibrations when the HMI emits an alarm.

### CROSS-REFERENCE TO RELATED APPLICATIONS

This application claims the benefit of French Application No. FR2407008, filed Jun. 28, 2024, the entire contents of which is hereby incorporated herein by reference.

### BACKGROUND

In the field of managing an industrial production line, in particular a beverage production line, it is well known that a programmable logic controller (PLC) is a digital computer used for automating electromechanical processes, such as controlling the machines on production lines. Unlike computers for general use, the programmable logic controller is designed for multiple inputs and outputs, wide temperature ranges, electrical noise immunity, and vibration and impact resistance. The programs for controlling the operation of the machines are generally stored in a non-volatile memory.

The main difference compared to personal computers (PCs) lies in the fact that PLCs are generally shielded in order to withstand difficult conditions (such as dust, moisture, heat, cold, etc.) and that they have a large number of inputs/outputs (I/O) for connecting to sensors and actuators, for example. Programmable logic controllers (PLCs) can thus be capable of reading limit switches, variables of analog processes (such as temperature and pressure), and the positions of complex positioning systems.

Programmable logic controllers (PLCs) can be used in critical environments in which faults can compromise the safety of workers, the public, and/or the environment, or result in significant costs. As a result, they are usually used on production lines for bottles and beverages in general.

In order to reduce the load on these controllers, programmable logic controllers (PLCs) are provided with other specific devices that form an interface for operating personnel. These devices are known as control and monitoring devices or human-machine interfaces, and more usually as HMIs.

The term HMI is a generic term that covers all of the components associated with this group of devices. Operator panels (OPs) are an example of this. These can be fixed or mobile. Furthermore, HMIs are frequently used in networked automation to help operating personnel display and control the process data of the technical unit to be operated. This function is known as a real-time supervisory control and data acquisition (SCADA) system. To this end, the HMI is generally provided with specific hardware. In other words, it is provided with a touchscreen, for example, and is specially protected from environmental influences. It is also provided with specific software. The software supplies functions that improve the user-friendliness, quality, and safety of the operations carried out by the operator. HMIs can thus be used to display, control, configure, and generate interactive process maps of the technical unit to be operated. This makes it possible to selectively display the responses of the technical unit, generally in the form of measured values and messages. In addition, the customized pre-definition of control operations and data inputs makes it possible to switch the technical unit to the required states.

HMIs are usually permanently incorporated, for example in the form of terminals, as fixed components in an automation system. These terminals are generally permanently connected to the PLC by cables. If these terminals are in the form of portable devices, their operating range is limited by a connection cable. In many cases, this ensures that an operator can only perform operations that are important for safety in direct proximity to the technical unit, or at least when there is suitable visual contact.

In order to overcome this drawback, it has already been envisaged that the HMI take the form of a mobile operator panel, such as a tablet computer or similar, for example. Such a mobile control and monitoring device can for example be connected to the automation system by a long-range radio link. In this case, it is not impossible for an operator using a mobile control and monitoring device to move so far away from an associated technical unit that operations that are important for safety are performed at a distance that is not permitted per se. In this case, personal safety could not be ensured.

This is the case in particular of EP2077473, which describes a method and system for accessing an element in a process control environment using a portable communicator, comprising defining a plurality of control areas within the process control environment, determining a position of a user operating a portable communicator with respect to one or more control areas, establishing an identity of the user, and selectively allowing the user to access an element within the process control environment via the portable communicator depending on the determined position of the user with respect to the one or more control areas and on the identity of the user.

Although these portable HMIs, unlike fixed HMIs that limit the view of the actuators of the machines and require the machine operator to walk around to see the result of their command on the fixed HMI, allow the operator to command the actuators of the machine “doors open” while standing in front of said open doors in order to view the result of their command, these portable HMIs do not allow the operator to be alerted of a new alarm when they are not looking at the screen of the HMI.

### SUMMARY

Embodiments of the present disclosure provide systems and methods for managing a production line comprising at least one machine, a human-machine interface (HMI) connected to at least one machine of said production line, and/or a portable device capable of being connected to said machine, said human-machine interface (HMI) being able to be connected to a computer-assisted production management (CAPM) system.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a schematic depiction of the structure of a bottle or beverage production line comprising a system for managing said line according to various example embodiments;

FIG. 2 is a schematic depiction of unit for manufacturing containers comprising a system for managing a production line according to various example embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

Among embodiments, some aspects of the present disclosure are implemented by a computer program executed by one or more processors, as described and illustrated. As would be apparent to one having ordinary skill in the art, the present disclosure may be implemented, at least in part, by computer-readable instructions in various forms, and the present disclosure is not intended to be limiting to a particular set or sequence of instructions executed by the processor.

The embodiments described herein are not limited in application to the details set forth in the following description or illustrated in the drawings. The disclosure is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above.

In accordance with the purpose(s) of the present disclosure, as embodied and broadly described herein, embodiments of the present disclosure, in some aspects, relate to overcoming the aforementioned drawbacks by providing a system for managing a bottle or beverage production line having a simple, low-cost design and allowing the operator to be alerted of a new alarm when they are not looking at the screen of the HMI in particular.

In general, embodiments of the present disclosure provide for a system for managing a production line is proposed, comprising at least one machine, said system comprising at least one human-machine interface (HMI) connected to a programmable logic controller (PLC) or to a distributed control system (DCS) or similar, of a machine of said production line, and/or a portable device; at least one remote terminal rigidly connected to the machine or to a safety enclosure of said machine and connected to the human-machine interface (HMI) or connected to the programmable logic controller (PLC) of the machine, said remote terminal comprising means for detecting the presence of the portable device inside a predetermined perimeter and means for connecting said portable device to the human-machine interface (HMI) and/or to the programmable logic controller (PLC) of the machine; notable in that said portable device and/or a portable accessory, connected to the portable device and/or to the remote terminal, comprises a device for generating vibrations capable of generating vibrations when the HMI emits an alarm.

In example embodiments, the means for detecting the presence of the portable device inside a predetermined perimeter may use a proximity sensor utilizing infrared, ultrasonic, or laser technology to sense the device's presence. Alternatively, an RFID reader may be employed, which utilizes radio frequency identification to detect the presence of an RFID-tagged portable device. A magnetic sensor could also be used to identify devices with magnetic components. In some embodiments, a camera-based system may be implemented, utilizing image recognition software to identify the device within a specific area. Additionally, a pressure sensor may detect changes in pressure in a defined area, indicating the presence of the device. A capacitive sensor could be utilized to sense the presence of the device based on changes in capacitance. Furthermore, an infrared beam break sensor may be employed to detect the interruption of an infrared beam caused by the device entering the perimeter.

In example embodiments, the means for connecting said portable device to the human-machine interface (HMI) and/or to the programmable logic controller (PLC) of the machine may include a Bluetooth module that enables short-range wireless communication. A Wi-Fi module may also be used to provide wireless connectivity to the HMI or PLC over a local network. In some cases, Zigbee or LoRa modules may be implemented for low-power, long-range wireless communication. A USB interface could serve as a physical connection for data transfer, while a serial communication interface (such as RS-232 or RS-485) may facilitate wired communication with the HMI or PLC. An Ethernet port could provide a direct network connection, and a CAN bus interface may be utilized for communication in industrial environments. Additionally, an NFC (Near Field Communication) module could be employed for very short-range communication.

According to one variant embodiment, said generated vibrations are continuous.

According to one variant embodiment, said generated vibrations are intermittent.

Furthermore, the duration of the generated vibrations depends on the type of alarm and/or the frequency of the generated vibrations depends on the type of alarm and/or the intensity of the generated vibrations depends on the type of alarm.

Additionally, the number and/or duration and/or frequency of the intermittent vibrations depends on the type of alarm.

Advantageously, a continuous or intermittent vibration signal is assigned to a particular alarm of the HMI, each vibration signal being pre-recorded in a memory of the HMI and/or of the portable device.

Said alarms of the HMI relate to a change of speed and/or the starting of a spindle and/or a production rate reached and/or a moving spindle and/or a prohibited movement and/or a torque threshold reached by the machine and/or a lag threshold reached by the machine and/or a limit or zone reached by the machine and/or a maximum and/or minimum setpoint reached and/or the detection of departure from the perimeter of the remote terminal and/or similar.

Furthermore, the portable device connects to the human-machine interface (HMI) and/or to the programmable logic controller (PLC) of the machine by means of a wireless network.

Said wireless network can include a WiFi, Bluetooth or Zigbee network.

Alternatively, each remote terminal is connected to the human-machine interface (HMI) and/or to the programmable logic controller (PLC) of the machine by a wired connection.

Preferably, the portable device connects automatically to the human-machine interface (HMI) and/or to the programmable logic controller (PLC) of the machine when said portable device is detected inside the perimeter of the remote terminal.

Secondarily, said portable device comprises means for customizing the human-machine interface (HMI) of the machine to which it is connected and said portable device comprises means for connecting to a remote server.

In example embodiments, the means for customizing the human-machine interface (HMI) of the machine may include a graphical user interface (GUI) builder that allows users to design and modify the HMI layout according to their preferences. A configuration file may store user preferences and settings for the HMI, while a touchscreen interface could enable direct interaction for customization. A mobile application may provide remote access to customize the HMI settings, and a web-based interface could serve as a browser-based platform for HMI customization. An API (Application Programming Interface) may allow developers to create custom functionalities for the HMI, and a template system may offer predefined templates that users can select and modify for the HMI.

In example embodiments, the means for connecting the portable device to a remote server may include a cellular modem that provides mobile network connectivity to access the internet. A Wi-Fi adapter may also be utilized for connecting to local Wi-Fi networks, while an Ethernet port could facilitate wired internet access. In remote areas without cellular or Wi-Fi coverage, a satellite communication module may be employed. A VPN (Virtual Private Network) client may be included for secure connections to remote servers, and an MQTT client may facilitate lightweight messaging to connect to IoT platforms. Additionally, a WebSocket client may be used for real-time communication with a remote server.

Turning now to the drawings, exemplary embodiments are described in detail.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure. In the remainder of the description of system according to the disclosure, the same reference signs denote the same elements. The various views are not necessarily drawn to scale.

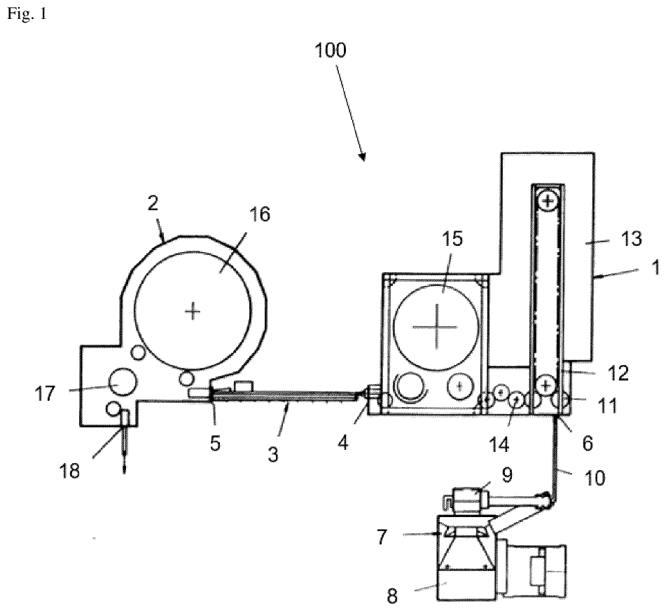

With reference to FIG. 1, the bottle or beverage production line 100 essentially comprises a unit 1 for manufacturing containers, such as bottles, from a thermoplastic material, a unit 2 for filling said containers, and a unit 3 for conveying the manufactured containers from the output 4 of the manufacturing unit 1 to the input 5 of the filling unit.

It will be observed that said bottle or beverage production line 100 can optionally also comprise a labelling unit and/or a container capping unit and/or a container surface treatment unit, of the type making it possible to apply a plasma barrier coating, not shown in FIG. 1, without departing from the scope of the invention.

The manufacturing unit 1 can be of any type suitable for manufacturing containers, such as bottles, from a thermoplastic material such as polyethylene terephthalate (PET), polyethylene naphthalate (PEN), or the like. It receives, at its input, preforms made from an amorphous material coming from a preform feed unit 7. The unit 7 can consist of or comprise a hopper 8 receiving loose preforms manufactured in advance by molding in another location, which hopper is connected to the input 6 by a sorter 9 that separates and positions the preforms on a conveying device 10 connected to the input 6 of the manufacturing unit (cold preform feed) as shown in FIG. 1. The unit 7 can also include the unit for molding the preforms itself, which delivers the preforms that have just been molded and are still hot directly to the input 6 of the manufacturing unit (hot preform feed).

The processing of the preforms in the manufacturing unit can be any type of processing appropriate to the type of containers to be produced (single-or two-stage blow molding, single or multiple heat treatment, etc.). For reasons of simplicity and clarity, FIG. 1 shows single treatment of the preforms that are mounted at 11 on a transfer chain 12 and then heated as they move through a tunnel oven 13 before being collected at 14 to be introduced, hot, into a blow-molding or stretch blow-molding device 15 having multiple molds arranged on a carousel. After controlled cooling, the containers that have just be manufactured are presented at the output 4 of the manufacturing unit 1.

The containers received at the input 5 of the filling unit 2 are positioned on a rotary filling device 16 from which, once filled, they are removed and presented to a capping device 17. The filled and capped containers are then discharged through the output 18 of the filling unit 2, to a labelling station and then a packaging station (not shown).

The container manufacturing unit 1 and the filling unit 2 are positioned as close as possible to each other so that the distance between the output 4 of the former and the input 5 of the latter is as short as possible. The conveying unit 3 that extends from the aforementioned output 4 to the aforementioned input 5 is therefore short, and the containers are introduced directly from the conveying unit 3 into the filling unit 2 without passing through a washing device, which is unnecessary due to the now greatly reduced risk of contamination inside the containers. Due to its short length, the conveying unit 3 can certainly be an air conveyor like the very long conveying devices used in current installations, but it can also be produced in a financially acceptable manner in the form of an endless chain conveyor, for example with grippers, that is capable of conveying the containers with constant spacing.

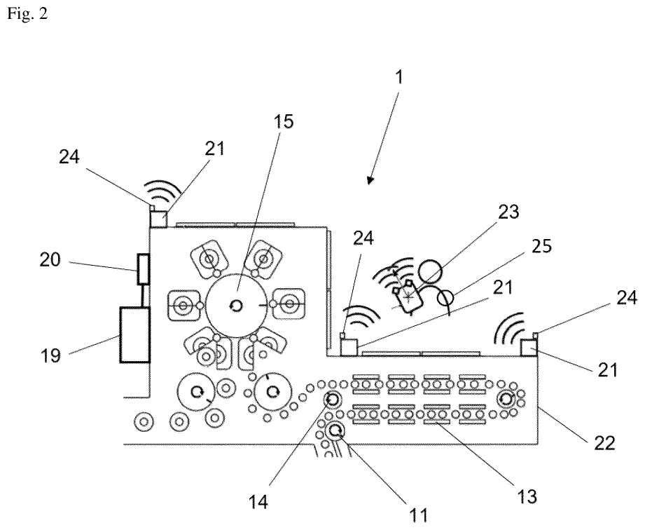

With reference to FIG. 2, the container manufacturing unit 1 comprises a programmable logic controller (PLC) 19 for controlling the various elements of said manufacturing unit 1, and a human-machine interface (HMI) 20 connected to said programmable logic controller 19.

Each unit, i.e. each machine, of the production line 100 comprises a programmable logic controller (PLC) and a human-machine interface (HMI), although only the container manufacturing unit 1 is shown in FIG. 1.

Secondarily, the programmable logic controller (PLC) can be replaced by a distributed control system (DCS) or similar without departing from the scope of the invention.

Furthermore, the system for managing a production line 100 comprises a remote terminal 21 rigidly connected to a safety enclosure 22 of the container manufacturing unit 1 and connected to the human-machine interface (HMI) 20 or connected to the programmable logic controller (PLC) 19 of said container manufacturing unit 1, said remote terminal 21 comprising means for detecting the presence of a portable device 23 inside a predetermined perimeter, and means for connecting said portable device 23 to the human-machine interface (HMI) 20 and/or to the programmable logic controller (PLC) 19 of the container manufacturing unit 1. It will be observed that, in this particular embodiment, the system for managing the production line 100 comprises a plurality of remote terminals 21 rigidly connected to the safety enclosure 22 in different locations, each remote terminal 21 being connected to the human-machine interface (HMI) 20 and/or to the programmable logic controller (PLC) 19 and respectively defining a predetermined perimeter inside which the portable device 23 can be detected, said portable device only connecting to the human-machine interface (HMI) 20 and/or to the programmable logic controller (PLC) 19 when said portable device 23 is located inside one of these predetermined perimeters of the remote terminals 21.

It is clear that the remote terminal or terminals 21 can be rigidly connected to each machine, i.e. to each container manufacturing unit 1, container filling unit 2, or container conveying unit 3, without departing from the scope of the invention.

Said portable device 23 can take the form of a computer terminal, a tablet or cell phone, a smart watch, or any device provided with a screen.

It will be observed that said portable device 23 can also comprise a holographic display surface, such as a holographic headset or holographic glasses, without departing from the scope of the invention.

The operator can thus carry said portable device 23 as they move along the production line 100, having direct access to all or some of the computerized management of a unit by means of said human-machine interface (HMI) 20. Furthermore, by means of said human-machine interface (HMI) 20, non-limitingly, the operator can select different operating modes of the container manufacturing unit 1, check the status of certain components, or monitor the production in progress, check potential anomalies, adjust settings, enter data relating to production, control and perform a maintenance step, etc.

Particularly advantageously, said portable device 23 and/or a portable accessory 25 connected to said portable device 23 and/or to the remote terminal 21, comprises a device for generating vibrations capable of generating vibrations when the human-machine interface (HMI) 20 emits an alarm. Said portable accessory 25 consists of or comprises, for example, a bracelet positioned on the wrist of the operator and connected by a Bluetooth link or similar. It is clear that said portable accessory 25 can consist of or comprise any other portable accessory, such as glasses for example, without departing from the scope of the invention.

Said generated vibrations are continuous or intermittent. The duration of the generated vibrations depends on the type of alarm and/or the frequency of the generated vibrations depends on the type of alarm and/or the intensity of the generated vibrations depends on the type of alarm. For intermittent generated vibrations, the number and/or duration and/or frequency of the intermittent vibrations depends on the type of alarm.

Furthermore, a continuous or intermittent vibration signal is assigned to a particular alarm of the human-machine interface (HMI) 20, each vibration signal being pre-recorded in a memory of the human-machine interface (HMI) 20 and/or of the portable device 23.

For example, the alarms of the human-machine interface (HMI) relate to a change of speed and/or the starting of a spindle and/or a production rate reached and/or a moving spindle and/or a prohibited movement and/or a torque threshold reached by the machine and/or a lag threshold reached by the machine (lag error) and/or a limit or zone reached by the machine and/or a maximum and/or minimum setpoint reached and/or the detection of departure from the perimeter of the remote terminal and/or similar.

It is clear that the alarms to which vibration signals are assigned can consist of or comprise any other type of alarm without departing from the scope of the invention.

Furthermore, advantageously, the portable device connects to the human-machine interface (HMI) 20 and/or to the programmable logic controller (PLC) 19 of the container manufacturing unit 1 by means of a wireless network. Said wireless network consists of or comprises a WiFi, Bluetooth or Zigbee network, or any other suitable wireless network. Each remote terminal 21 is connected to the human-machine interface (HMI) 20 and/or to the programmable logic controller (PLC) 19 of the container manufacturing unit 1 by a wired connection, not shown in FIG. 2.

Preferably, the portable device 23 connects automatically to the human-machine interface (HMI) 20 and/or to the programmable logic controller (PLC) 19 of the container manufacturing unit 1 when said portable device 23 is detected inside the perimeter of the remote terminal 21. However, the connection of the portable device 23 can also be obtained by a request sent by the operator by means of said portable device 23, said request then being transmitted to the human-machine interface (HMI) 20 and/or to the programmable logic controller (PLC) 19 via the remote terminal 21 corresponding to the predetermined perimeter inside which the portable device 23 is located, the human-machine interface (HMI) 20 and/or the programmable logic controller (PLC) 19 sending confirmation of the connection back to the portable device 23 via the remote terminal 21.

In addition, the human-machine interface (HMI) 20 of the machine comprises means for configuring said perimeter in the form of a predetermined distance with respect to the remote terminal 21. In example embodiments, the means for configuring said perimeter in the form of a predetermined distance with respect to the remote terminal may include a user interface (UI) control, such as a slider or input field in the HMI, that allows users to set the perimeter distance. A mobile app configuration may enable users to set the perimeter distance remotely. In some cases, a physical control panel with buttons or dials on the machine may allow for manual configuration. A voice command interface could also be implemented, allowing users to set the perimeter using voice commands. Geofencing software may be utilized to define the perimeter based on GPS coordinates, and a configuration API may allow external systems to set the perimeter programmatically. Lastly, a remote configuration tool may provide a web-based platform for users to adjust settings from anywhere.

Secondarily, said portable device 23 comprises at least one camera, not shown in the figures, in order to allow the operator to film an element of the machine and send the corresponding video to a remote technical support system. In this regard, secondarily, said portable device 23 can advantageously comprise optional audio communication means in order to communicate with a remote troubleshooting service and/or means for connecting to a remote server, such as a remote server of said remote technical support system, for example, said server comprising in particular a database of the technical drawings of the machine.

Furthermore, said portable device 23 comprises means for customizing the human-machine interface (HMI) 20 of the machine to which it is connected.

In addition, said portable device 23 comprises means for connecting to a remote server.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

Therefore, at least the following is claimed:

1. A system for managing a production line, comprising at least one machine, said system comprising at least:
one human-machine interface (HMI) connected to one or more of a programmable logic controller (PLC) of a machine of said production line, a distributed control system (DCS) or similar, and a portable device; and
at least one remote terminal rigidly connected to the machine or to a safety enclosure of said machine and connected to the human-machine interface or connected to the programmable logic controller of the machine, said remote terminal comprising a detector for detecting a presence of the portable device inside a predetermined perimeter and a connector for connecting said portable device to the human-machine interface and/or to the programmable logic controller of the machine,
wherein one or both of said portable device and a portable accessory, connected to said portable device and/or to the remote terminal, comprises a device for generating vibrations capable of generating vibrations when the HMI emits an alarm.

2. The system for managing a production line as claimed in claim 1, wherein said generated vibrations are continuous.

3. The system for managing a production line as claimed in claim 1, wherein said generated vibrations are intermittent.

4. The system for managing a production line as claimed in claim 1, wherein a duration of the generated vibrations depends on a type of alarm.

5. The system for managing a production line as claimed in claim 1, wherein a frequency of the generated vibrations depends on a type of alarm.

6. The system for managing a production line as claimed in claim 1, wherein an intensity of the generated vibrations depends on a type of alarm.

7. The system for managing a production line as claimed in claim 3, wherein one or more of a number, a duration, and a frequency of the intermittent vibrations depends on a type of alarm.

8. The system for managing a production line as claimed in claim 2, wherein a continuous or intermittent vibration signal is assigned to a particular alarm of the HMI, each vibration signal being pre-recorded in a memory of one or both of the HMI and the portable device.

9. The system for managing a production line as claimed in claim 1, wherein the alarms of the HMI relate to one or more of:
a change of speed,
the starting of a spindle,
a production rate reached,
a moving spindle,
a prohibited movement,
a torque threshold reached by the machine,
a lag threshold reached by the machine,
a limit or zone reached by the machine,
a maximum setpoint reached,
a minimum setpoint reached, and
the detection of departure from the perimeter of the remote terminal.

10. The system for managing a production line as claimed in claim 1, wherein the portable device connects to one or both of the human-machine interface and the programmable logic controller of the machine via a wireless network.

11. The system for managing a production line as claimed in claim 10, wherein said wireless network consists of a WiFi, Bluetooth or Zigbee network.

12. The system for managing a production line as claimed in claim 1, wherein each remote terminal is connected to the human-machine interface, the programmable logic controller of the machine, or both by a wired connection.

13. The system for managing a production line as claimed in claim 1, wherein the portable device automatically connects to one or both of the human-machine interface and the programmable logic controller of the machine when said portable device is detected inside the perimeter of the remote terminal.

14. The system for managing a production line as claimed in claim 1, wherein said portable device comprises means for customizing the human-machine interface of the machine to which it is connected.

15. The system for managing a production line as claimed in claim 1, wherein said portable device comprises means for connecting to a remote server.
